(19) United States
(12) Patent Application Publication
(10) Pub. No.: US 2026/0317993 A1
(43) Pub. Date: Oct. 15, 2026

(54) CLOTHING TREATMENT DEVICE

(71) Applicant: LG Electronics Inc., Seoul (KR)

(72) Inventors: Heesang YOON, Seoul (KR); Byoungjoon HAN, Seoul (KR)

(73) Assignee: LG Electronics Inc., Seoul (KR)

(21) Appl. No.: 19/149,806

(22) PCT Filed: Sep. 13, 2023
(86) PCT No.: PCT/KR2023/013746

§ 371 Date: Jul. 21, 2025

(30) Foreign Application Priority Data
Nov. 17, 2022 (KR) 10-2022-0154418

(51) Int. Cl. D06F 73/02; B01D 35/02

(52) U.S. Cl. CPC D06F 73/02; B01D 35/02

(57) ABSTRACT

The present invention relates to a clothing treatment device comprising: a storage chamber in which clothes are stored; an electric chamber disposed under the storage chamber; a steam unit installed inside the electric chamber and supplying steam into the storage chamber; and a tank unit installed in the electric chamber, and filtering water supplied from the storage chamber and then supplying same to the steam unit.

### TECHNICAL FIELD

The present invention relates to a clothing treatment device in which recovered water for drain can be reused as water for water supply.

### BACKGROUND ART

In general, a clothing treatment device denotes any device for clothing management or treatment, such as washing, drying, and wrinkle removal of clothing or bedding, in a home, laundry or the like.

Examples of the clothing treatment device include a washing machine for clothing washing, a dryer for clothing drying, a washer cum dryer performing both washing and drying functions, a refresher for clothing refreshing treatment, an iron for removing unnecessary wrinkles or creating necessary wrinkles in clothing, a steamer for removing unnecessary wrinkles in clothing, and the like.

More specifically, the refresher is a device for making clothing more pleasant and fresh, which performs functions such as drying clothing, adding fragrance to clothing, preventing static electricity of clothing, and removing wrinkles of clothing.

The steamer is generally a device removing wrinkles from clothing simply by supplying steam, and unlike a conventional iron, it does not bring a heated plate into contact with the clothing, thus allowing for delicate wrinkle removal.

A clothing treatment device incorporating both the function of the refresher and the function of the steamer can perform functions such as wrinkle and odor removal from the clothing stored inside by using steam and hot air. By means of these functions, the clothing regeneration apparatus can remove, from the clothing stored therein, odor particles that have contaminated the clothing, or remove wrinkles in the clothing, thereby providing an ironing effect.

The clothing treatment device generating steam includes a water supply tank for supplying water to a steam generator, and a drain tank for draining condensate generated in the clothing treatment device to the outside.

In the related art, the water supply tank and the drain tank are provided separately, and it is frequently required to separate each tank from the clothing treatment device in order to supply water to the water supply tank and discard the water stored in the drain tank, which problematically causes increased inconvenience.

The background art of the present invention is disclosed in Korean Patent Registration No. 10-2434109 (Registration Date: Aug. 16, 2022, Title of the invention: Clothes Treating Apparatus).

### DISCLOSURE

### Technical Problem

It is an object of the present invention to provide a clothing treatment device in which water for drain stored in a drain tank can be reused as water for water supply by transferring it to a water supply tank.

Also, it is an object of the present invention is to provide a clothing treatment device in which the drain tank and the water supply tank can be separated or coupled as one body.

Also, it is an object of the present invention to provide a clothing treatment device in which the installation space of the drain tank and the water supply tank can be saved.

The objects of the present invention are not limited to the ones mentioned above, and other objects and advantages of the present invention which are not mentioned can be appreciated from the following description, and will be more clearly appreciated by the embodiments of the present invention. Furthermore, it is readily understood that the objects and advantages of the present invention can be achieved by the means set forth in the claims and combinations thereof.

### Technical Solution

The clothing treatment device according to the present invention, which has been conceived to solve the above-described problems, is technically characterized in that water for drain stored in the drain tank is transferred to the water supply tank to be reused as water for water supply.

Specifically, when water for drain is supplied to the inside of the drain tank mounted in the inside of the water supply tank, the water passes through the filter part and is then supplied into the inside of the water supply tank, so that it can be reused as water for water supply of the steam unit.

Additionally, the present invention is characterized in that the drain tank and the water supply tank are separated or combined as one body.

Specifically, through the water supply inlet provided at the upper side of the water supply tank, the drain tank is moved and engaged in the inside of the water supply tank, so the coupling and separation of the drain tank can be easily performed.

Also, the present invention has a technical feature of saving the installation space of the drain tank and the water supply tank.

Specifically, since the drain tank is installed in the inside of the water supply tank, installation space can be saved compared to tanks which are installed separately as the drain tank and the water supply tank.

The clothing treatment device according to an embodiment of the present invention includes a storage chamber in which clothing is stored, an electrical component chamber located in a lower side of the storage chamber, a steam unit installed in an inside of the electrical component chamber, and supplying steam to an inside of the storage chamber, and a tank part installed in the electrical component chamber, filtering water supplied from the storage chamber, and then supplying water to the steam unit.

Additionally, the tank part includes a water supply tank storing water to be supplied to the steam unit, and a drain tank detachably installed in an inside of the water supply tank, receiving and filtering water drained from the storage chamber, and then supplying the filtered water to the water supply tank.

Additionally, the drain tank includes a storage part having an open upper side to form a drain inlet, engaged in an inside of the water supply tank, and storing therein water that has fallen through the drain inlet, and a filter mounting part connected to a second base which is a bottom of the storage part, and protruding downward from the storage part to form a space in which a filter part is installed.

The clothing treatment device according to an embodiment of the present invention includes a storage chamber in which clothing is stored, an electrical component chamber located in a lower side of the storage chamber, a steam unit installed in an inside of the electrical component chamber, and supplying steam to an inside of the storage chamber, a water supply tank storing water to be supplied to the steam unit, a drain tank detachably installed in an inside of the water supply tank, receiving and filtering water drained from the storage chamber, and then supplying the filtered water to the water supply tank, and a filter part installed in the drain tank, and purifying water that moves from the drain tank to the water supply tank.

### Advantageous Effects

Since the water for drain stored in the drain tank is delivered to the water supply tank to be reused as water for water supply, the clothing treatment device according to the present invention can increase the time at which the water for water supply is replenished, thereby improving user convenience.

Also, since the drain tank is installed in the inside of the water supply tank, the present invention can save installation space.

Also, since the drain tank is moved through the water supply inlet provided at the upper side of the water supply tank and is engaged in the inside of the water supply tank, the present invention can save the time spent on the coupling and separation of the drain tank.

Also, since the drain tank can be easily separated from the water supply tank, the present invention can reduce the time and cost required for cleaning the drain tank and the water supply tank.

Also, since the water supply tank is installed in a shape surrounding the outer side of the drain tank, the present invention can prevent the occurrence of safety accidents which would otherwise be caused by water leakage generated from the drain tank.

In addition to the effects described above, specific effects of the present invention will be described below together with specific matters for practicing the invention.

### DESCRIPTION OF DRAWINGS

FIG. 1 is a perspective view of a clothing treatment device according to an embodiment of the present invention.

FIG. 2 is a front view showing an electrical component chamber in which a tank part according to an embodiment of the present invention is installed.

FIG. 3 is a drawing showing the tank part and a steam unit according to an embodiment of the present invention.

FIG. 4 is a perspective view showing the tank part according to an embodiment of the present invention.

FIG. 5 is a perspective view showing a state in which the drain tank is separated from the water supply tank according to an embodiment of the present invention.

FIG. 6 is an exploded perspective view of the tank part according to an embodiment of the present invention.

FIG. 7 is a diagram showing the internal configuration of the tank part according to an embodiment of the present invention.

FIG. 8 is a diagram showing a state in which water is stored in the water supply tank according to an embodiment of the present invention.

FIG. 9 is a diagram showing a state in which water has entered the drain tank according to an embodiment of the present invention.

FIG. 10 is a diagram showing a state in which the water stored in the drain tank has moved to the water supply tank through the filter part, according to an embodiment of the present invention.

FIG. 11 is a diagram showing a state in which the drain tank is filled with water because the filter part is clogged, according to an embodiment of the present invention.

FIG. 12 is a block diagram of the clothing treatment device according to an embodiment of the present invention.

### BEST MODE

The purposes, features and advantages described above will be described in detail below with reference to the accompanying drawings, so that a person having ordinary knowledge in the technical field to which the present invention pertains can easily practice the technical concept of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference numerals are used to refer to like or similar components.

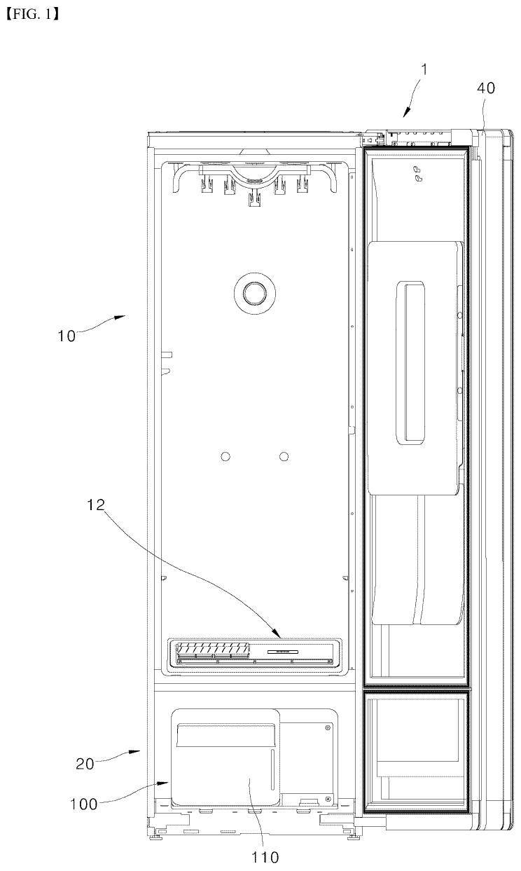

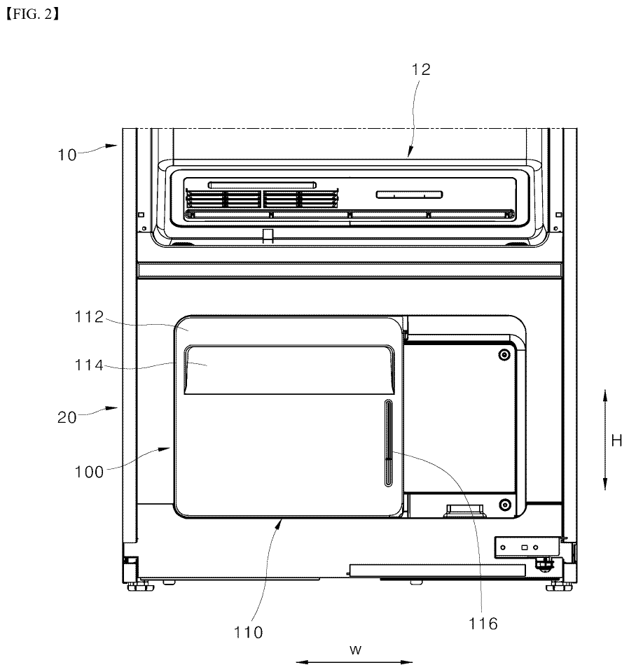

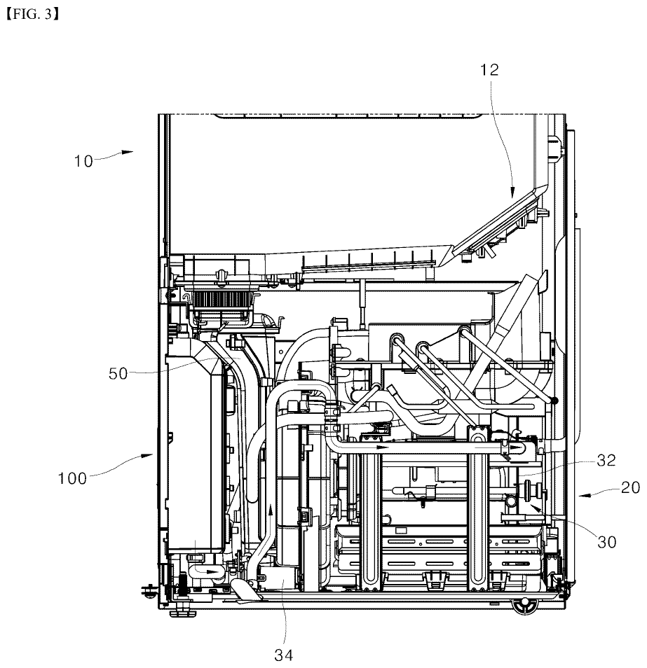

FIG. 1 is a perspective view of a clothing treatment device 1 according to an embodiment of the present invention; FIG. 2 is a front view showing an electrical component chamber 20 in which a tank part 100 according to an embodiment of the present invention is installed; and FIG. 3 is a drawing showing the tank part 100 and a steam unit 30 according to an embodiment of the present invention.

As shown in FIGS. 1 to 3, the clothing treatment device 1 has an outer appearance of a rectangular parallelepiped shape, and includes a storage chamber 10 in which clothing management is performed on clothing stored therein, the electrical component chamber 20 installed in the lower side of the storage chamber 10, and a door part 40 opening or closing a front side of the storage chamber 10.

In order to spray steam into the storage chamber 10, the steam unit 30 is installed in the inside of the electrical component chamber 20. In the conventional clothing treatment device 1, a tank containing water for water supplying water to the steam unit 30, and a tank for storing water recovered from the storage chamber 10 are respectively provided.

Therefore, in the conventional case, there was inconvenience in that the operation of refilling or emptying the water of the two separately provided tanks was frequently performed.

According to the clothing treatment device 1 according to the present invention, a drain tank 140 is installed in the inside of a water supply tank 120, and water supplied to the drain tank 140 is filtered at a filter part 180, and then is delivered to the water supply tank 120, so that the water can be reused. As a result, the time interval of the resupplies caused by a shortage of water due to natural water evaporation in the drain tank 140 and the like is increased, thereby improving user convenience.

The tank part 100 can be variously modified within the technical concept in which it allows water supplied from the storage chamber 10 to be filtered and then supplied to the steam unit 30. Merely by installing the filter part 180 in a middle portion of the tank part 100 formed as a single structure without making the drain tank 140 and the water supply tank 120 separately, a device for filtering water can be provided. Alternatively, the drain tank 140 and the water supply tank 120 may be installed in a separated state, and the filter part 180 may be installed in a pipe connecting between the drain tank 140 and the water supply tank 120 to provide a device for reusing water, and, including this, various modified embodiments are possible.

The tank part 100 according to an embodiment of the present invention has the drain tank 140 and the water supply tank 120 formed integrally, and a portion of the space of the water supply tank 120 is used as the drain tank 140. It is installed so that the drain tank 140 is installed in the inside of the water supply tank 120, and the drain tank 140 is movable to an upper side of the water supply tank 120, so that attachment and detachment operations can be performed easily.

Water stored in the drain tank 140 passes through the filter part 180 by gravity, and moves to the water drain tank 140 in the lower side. Therefore, by purifying the water supplied to the drain tank 140 and supplying it to the drain tank 140, a circulation structure of water can be achieved.

The drain tank 140 installed in the inside of the water supply tank 120 can be separated upward from the water supply tank 120, and the filter part 180 installed in the inside of the drain tank 140 can also be separated upward from the drain tank 140.

Meanwhile, in the case where external water is supplied to the water supply tank 120, the drain tank 140 may be separated from the water supply tank 120, and then the water may be supplied to the water supply tank 120.

By dividing the inner space of the water supply tank 120, a portion is used as a space in which the drain tank 140 is installed. The inner space of the water supply tank 120 may be divided into horizontal sections or divided into vertical sections. The inner space of the water supply tank 120 according to an embodiment of the present invention is divided into horizontal sections, and in the upper side, the drain tank 140 is installed, while, in the lower side, a space in which water dropped from the drain tank 140 is stored is formed.

The clothing treatment device 1 according to an embodiment of the present invention includes the storage chamber 10, the electrical component chamber 20, the steam unit 30, the door part 40, a water collecting tank 50, and the tank part 100.

The storage chamber 10 forms a space in which clothing is stored, and steam generated from the steam unit 30 is supplied to the inside of the storage chamber 10. The storage chamber 10 is a box shape of a rectangular parallelepiped extending in a vertical direction H, and its front side is in an open state.

In the lower side of the storage chamber 10, a steam discharge part 12 for supplying steam to the inside of the storage chamber 10 is installed. The steam discharge part 12 functions as a passage for guiding steam, which is supplied through the steam unit 30, to an upper space.

Clothing, shoes, hats, and the like are stored in the inside of the storage chamber 10, and wrinkles of clothing and the like can be removed by the steam supplied to the inside of the storage chamber 10, and odors emitted from clothing and the like can be removed.

The electrical component chamber 20 is located in the lower side of the storage chamber 10, and in the inside of the electrical component chamber 20, the steam unit 30, the water collecting tank 50, and the tank part 100 are installed. The electrical component chamber 20 has a box shape of a hexahedron, like the storage chamber 10, and its front side is in an open state for attaching and detaching the tank part 100.

The storage chamber 10 and the electrical component chamber 20 may be connected as an integral case, and the front sides of the storage chamber 10 and the electrical component chamber 20 are opened or closed by the door part 40.

The steam unit 30 is installed in the inside of the electrical component chamber 20, and various modifications can be made to this within the technical concept in which it supplies steam to the inside of the storage chamber 10. The water discharged from the tank part 100 passes through the transfer pump 34, and is then transferred to the steam generator 32 which generates steam.

Steam generated from the steam generator 32 is supplied to the inside of the storage chamber 10 through the steam discharge part 12. Steam supplied to the storage chamber 10 is adsorbed to targets such as dust particles or odor particles in the inside the storage chamber 10, then falls downward, and is stored in the inside of the water collecting tank 50.

The water collecting tank 50 is located in the inside of the electrical component chamber 20, and has a tank shape extending in a vertical direction H. The upper side of the water collecting tank 50 is open, and the inlet of the water collecting tank 50 is located at the bottom of the storage chamber 10.

The drain pump 52 is installed in a pipe extended from the water collecting tank 50, and is operated by a control signal of a controller 300. The drain pump 52 supplies water to the drain tank 140 in the case where the water level of the drain tank 140 is below a preset water level.

The end of a drain pipe (not shown) connected to the drain pump 52 is located in a movement path of the tank part 100. Accordingly, by the operation of the tank part 100 being installed in the electrical component chamber 20, the drain pipe is connected to the tank part 100.

Meanwhile, by the door part 40 rotatably installed on the storage chamber 10 and the electrical component chamber 20, the front side of the storage chamber 10 is opened or closed. The door part 40 may be made of a single piece, and depending on necessity, may be made of a plurality of pieces.

In the case where the door part 40 is made of a plurality of pieces, various modified embodiments are possible, such as a clothing ironing function being included in the inside of the door part 40.

The tank part 100 is detachably installed in the electrical component chamber 20, and various modifications can be made to this within the technical concept in which it receives water drained from the storage chamber 10, filters it, and then supplies it to the steam unit 30. The tank part 100 according to an embodiment of the present invention includes a plurality of tank structures in its inside, and includes a tank storing water recovered from the storage chamber 10 and a tank storing water to be supplied to the steam unit 30.

The tank part 100 according to an embodiment of the present invention has the drain tank 140 detachably installed in the inside of the water supply tank 120, so that the space where the tank part 100 is installed can be saved, and internal cleaning of the tank part 100 can be easily performed.

Based on the filter part 180 installed in the inside of the tank part 100, in the upper side of the filter part 180, recovered water is stored, and in the lower side of the filter part 180, purified water is stored. The inside of the tank part 100 is divided based on vertical direction, the drain tank 140 is installed in the upper side, and the main components of the water supply tank 120 are located in the lower side.

Water stored in the drain tank 140 moves by gravity, so it passes through the filter part 180 installed in the lower side of the drain tank 140 while foreign substances are removed therefrom, and then moves to the water supply tank 120.

The tank part 100 recycles water received through drainage, and sends it to the steam unit 30, so compared to the conventional ones, it can delay the timing of water supply and drainage, thereby further improving customer convenience.

Also, it is possible to reduce the water leakage risk because only the single tank part 100 is installed in the electrical component chamber 20, whereas the conventional ones has suffered from the high water leakage risk because two tanks are separately installed in the electrical component chamber 20, which thus leads to the separation or mounting of two tanks from or in the electrical component chamber 20.

The tank part 100 according to an embodiment of the present invention includes the water supply tank 120, the drain tank 140, and the filter part 180. Also, the tank part 100 according to an embodiment of the present invention may include at least one of a front cover 110, a drain valve 190, a first water level sensor 200, a second water level sensor 230, a tank cover 240, and a drain connector 250.

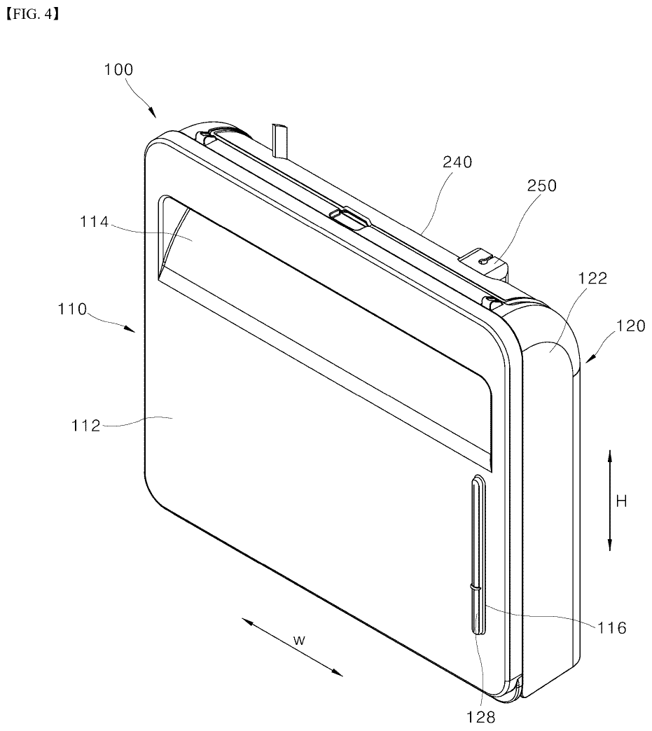

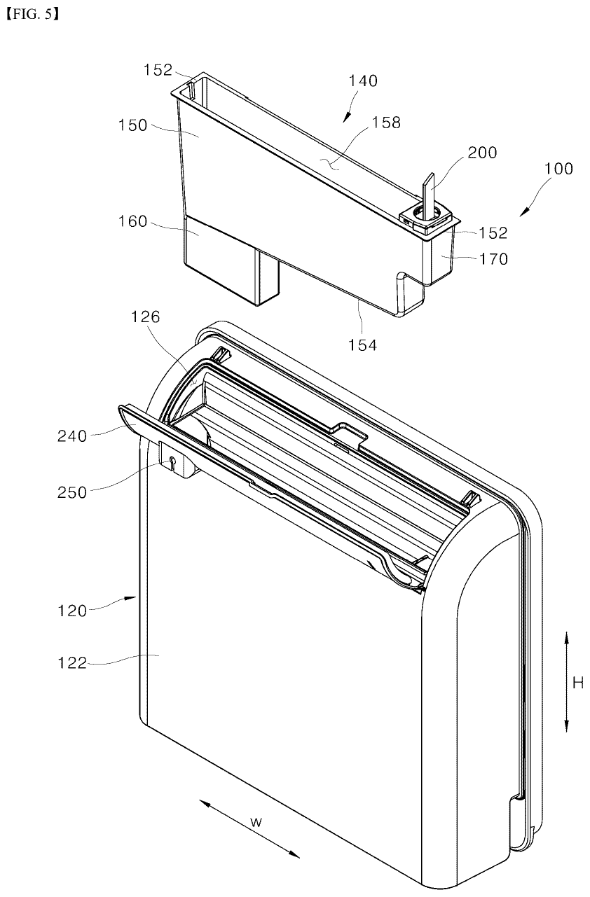

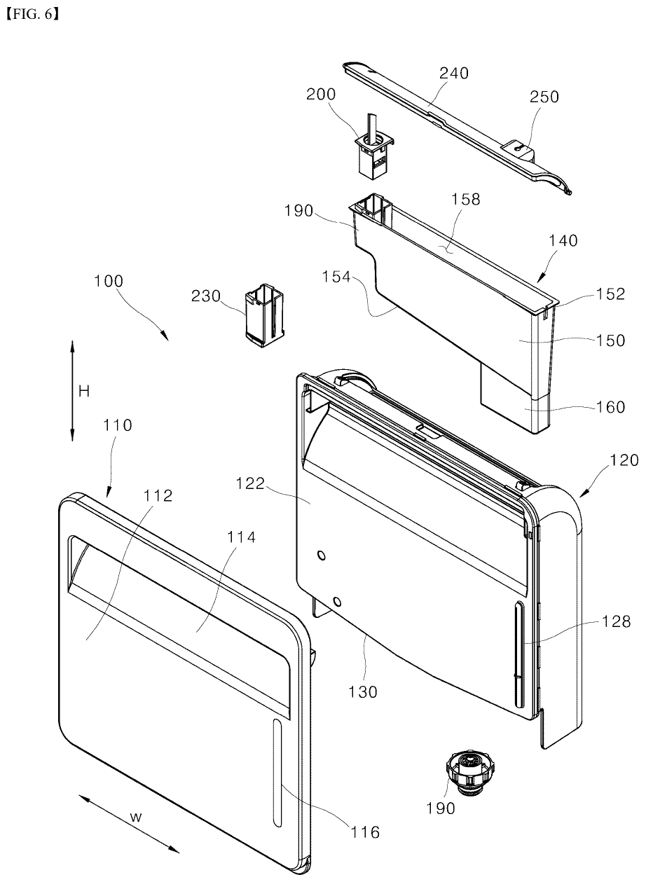

FIG. 4 is a perspective view showing the tank part 100 according to an embodiment of the present invention; FIG. 5 is a perspective view showing a state in which the drain tank 140 is separated from the water supply tank 120 according to an embodiment of the present invention; and FIG. 6 is an exploded perspective view of the tank part 100 according to an embodiment of the present invention.

As shown in FIGS. 4 to 6, the front cover 110 may be coupled to the front surface of the water supply tank 120 to be moved together with the water supply tank 120. The front cover 110 may be formed integrally with the front surface of the water supply tank 120, or be a separate member from the water supply tank 120 so that it can be detachably installed on the water supply tank 120, and including these, various modified embodiments are possible.

The front cover 110 according to an embodiment of the present invention may include a cover body 112, a handle part 114, and a water level checking part 116.

The cover body 112 has a plate shape covering the front surface of the tank part 100, and is detachably installed on the tank part 100. The cover body 112 includes the concave groove-shaped handle part 114 to be gripped by the user's hand. The handle part 114 is formed in the upper portion of the cover body 112, and forms a concave-shaped groove in the inward direction toward the tank part 100.

Also, the water supply tank 120 facing the handle part 114 also has a groove shape corresponding to the handle part 114. Thereby, a portion of the front cover 110 including the handle part 114 is engaged with the concave groove portion of the water supply tank 120, so the binding force between the front cover 110 and the water supply tank 120 is improved.

In the cover body 112 of the front cover 110 a window-shaped water level checking part 116 is provided to extend in the vertical direction H. In the front surface of the water supply tank 120 an inner water level window 128 is provided for checking the water level of the water stored in the water supply tank 120 with naked eye.

And the water level checking part 116 is also provided in the cover body 112 facing the inner water level window 128. The water level checking part 116 may be an elongated hole, and may also be a window made of transparent material. Thereby, the user can easily grasp the amount of water stored in the water supply tank 120 through the water level checking part 116 and the inner water level window 128.

The water supply tank 120 can be modified variously within the technical concept in which it stores water to be supplied to the steam unit 30. The water supply tank 120 according to an embodiment of the present invention may include a tank body 122, a water supply inlet 126, and the inner water level window 128.

Because the water supply tank 120 is installed in a shape that surrounds the outer side of the drain tank 140, it is possible to prevent occurrence of safety accidents caused by water leakage occurring in the drain tank 140.

The tank body 122 has an empty inside, and is formed in an approximately rectangular parallelepiped shape. The tank body 122 has an upright shape, and inside the tank body 122, the drain tank 140 is installed. The tank body 122 is installed in a shape that surrounds the outer side of the drain tank 140, and is provided with a space therein for storing water falling from the drain tank 140 through the filter part 180.

Only the water supply tank 120 including the tank body 122 may be installed without the drain tank 140 and the filter part 180, but since the steam unit 30 may break down due to foreign substances included in the recovered water, the drain tank 140 and the filter part 180 are installed in the inside of the tank body 122.

The upper side of the tank body 122 for storing water is opened to form the water supply inlet 126. The drain tank 140 installed in the tank body 122 can be moved through the water supply inlet 126 in the vertical direction H, so the attachment and detachment of the drain tank 140 can be easily performed.

Since the drain tank 140 is moved through the water supply inlet 126 provided on the upper side of the water supply tank 120 and the drain tank 140 is engaged in the inside of the water supply tank 120, time required for coupling and separation of the drain tank 140 can be saved. Also, since the drain tank 140 can be easily separated from the water supply tank 120, time and cost required for cleaning the drain tank 140 and the water supply tank 120 can be reduced.

The inner water level window 128 extends in the vertical direction H along the surface of the tank body 122 and is made of a transparent material to serve as a window for observing the height of water contained in the tank body 122.

At the outlet in the lower portion of the tank body 122, the drain valve 190 is installed. The drain valve 190 is a check valve, and when the tank part 100 is installed in the electrical component chamber 20, the drain valve 190 is brought into contact with a protrusion-shaped structure provided in the electrical component chamber 20, so that it is opened. Alternatively, the drain valve 190 may be operated electronically to open or close the flow path by a control signal from the controller 300, and including this, various modified embodiments are possible.

The drain valve 190 according to an embodiment of the present invention is connected to the lower portion of the water supply tank 120, and various modifications are possible to this within the technical concept in which water discharge is performed when the water supply tank 120 is coupled to the electrical component chamber 20. The drain valve 190 according to the present invention is pressed downward by the force of a spring, and is a check valve which, when the tank part 100 is coupled to the electrical component chamber 20, is pressed by a protrusion provided in the electrical component chamber 20 to open the flow path.

A first base 130 forming the bottom of the water supply tank 120 is installed to be inclined downward toward the drain valve 190, so discharge of the water stored in the water supply tank 120 can be carried out more quickly and easily. The drain valve 190 according to an embodiment of the present invention is located at the center in the width direction W of the tank body 122, and the first base 130 is installed to be inclined downward toward the center in the width direction W of the tank body 122.

The drain tank 140 can be modified variously within the technical concept in which it is installed detachably in the inside of the supply tank 120. The drain tank 140 is supplied with and stores water drained from the storage chamber 10, and can be modified variously within the technical concept in which the water moving to the lower side of the drain tank 140 passes through the filter part 180 while being filtered, and then moves to the supply tank 120. The drain tank 140 according to an embodiment of the present invention includes a storage part 150 and a filter mounting part 160. Also, the drain tank 140 can additionally include a guide unit 170.

Since the water for drain is stored in the drain tank 140 and transferred to the supply tank 120 to be reused as water for water supply, the cycle of replenishing water for water supply becomes longer, which can reduce the user's effort to refill water.

The storage part 150 is fixed inside the supply tank 120 with its engaging shape, and is provided with a space therein for storing water. Also, the storage part 150 has an open upper side to form a drain inlet 158, and stores therein the water falling through the drain inlet 158, while allowing the water to move to the supply tank 120 through the filter part 180 installed in the lower side.

The storage part 150 according to an embodiment of the present invention is formed in a box shape of a rectangular parallelepiped with the upper side open. The second base 154 forming the bottom of the storage part 150 is installed to be inclined downward toward the filter mounting part 160.

The filter mounting part 160 is connected to the second base 154, which is the bottom of the storage part 150, and various modifications can be made to this within the technical concept in which it protrudes downward from the storage part 150 to form a space in which the filter part 180 is installed. The filter mounting part 160 according to an embodiment of the present invention protrudes downward from the storage part 150, and has a rectangular pipe shape with the upper and lower sides open.

The upper side of the filter mounting part 160 is connected to the lower part of the storage part 150, and the lower portion of the filter mounting part 160 is connected to the inside of the water supply tank 120. In the inside of the filter mounting part 160 a filter part 180 is installed detachably. The water stored in the storage part 150 moves downward through the filter mounting part 160, and foreign substances contained in the water are removed by the filter part 180.

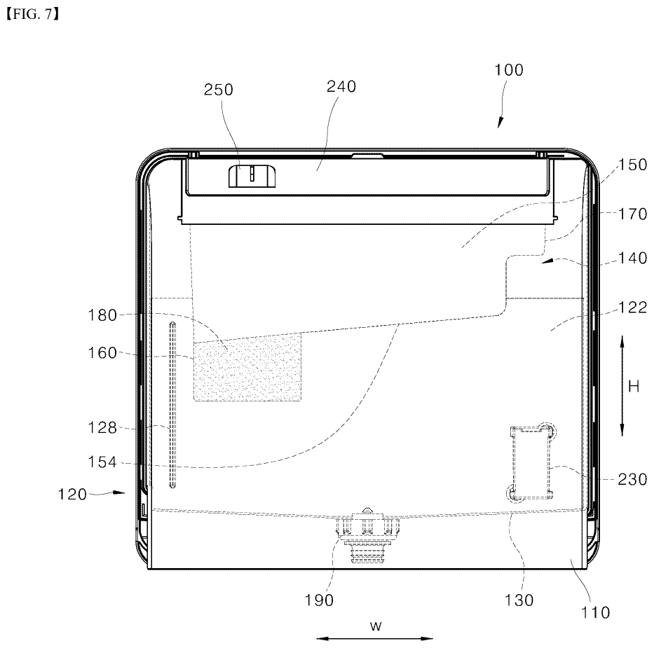

FIG. 7 is a diagram showing the internal configuration of the tank part 100 according to an embodiment of the present invention.

As shown in FIG. 7, the filter part 180 is installed in the filter mounting part 160 provided in the drain tank 140, and purifies the water moving from the drain tank 140 to the water supply tank 120.

The filter part 180 has a shape corresponding to the filter mounting part 160 in order to be installed detachably in the inside of the filter mounting part 160. The filter part 180 according to an embodiment of the present invention has a shape of an approximately rectangular parallelepiped, and is located in the inside of the filter mounting part 160.

The distance between the second base 154 forming the bottom of the drain tank 140 and the first base 130 forming the bottom of the water supply tank 120 is formed to be greater than the distance between the first base 130 and the lower end of the filter mounting part 160.

Therefore, the filter part 180 is located below the water stored in the drain tank 140, and the water stored in the water supply tank 120 is located below the filter part 180. The water in the drain tank 140 moves downward by gravity and passes through the filter part 180, and the water that has passed through the filter part 180 moves downward and is stored in the water supply tank 120.

From the upper side toward the lower side, the storage part 150, the filter mounting part 160, and the first base 130 of the water supply tank 120 are sequentially installed, so the movement of water is achieved by gravity, and thus a separate motor is not used to move the water.

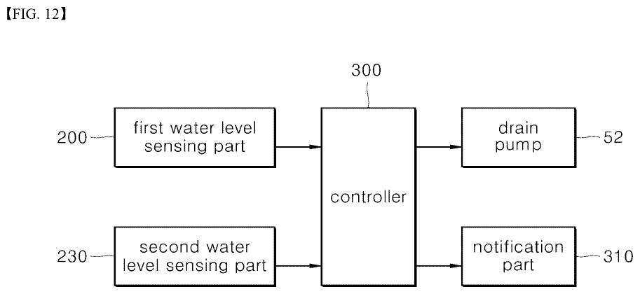

FIG. 12 is a block diagram of the clothing treatment device 1 according to an embodiment of the present invention.

As shown in FIG. 7 and FIG. 12, the first water level sensing part 200 is installed in the inside of the drain tank 140, and is moved up and down according to the water level in the drain tank 140. The first water level sensing part 200, which measures the height of the water stored in the drain tank 140, may operate electronically or in a manner of using buoyancy, and various types of sensors can be used as the first water level sensing part 200.

On one side in the width direction W of the storage part 150, the guide part 170 is installed which guides the up-and-down movement of the first water level sensing part 200. Since the guide part 170 is provided, on its side, with a passage connected to the inside of the storage part 150, the water stored in the storage part 150 moves also into the inside of the guide part 170.

Therefore, when the water stored in the drain tank 140 is stored above a set height, the water is also supplied into the inside of the guide part 170, thereby moving the first water level sensing part 200 upward, so the first water level sensing part 200 can be operated.

In the case where the filter part 180 is clogged and the water rises in the drain tank 140, the first water level sensing part 200 is operated.

The second water level sensing part 230 is installed inside the water supply tank 120, and is operated, when the water stored in the water supply tank 120 is at a low level, to transmit the measured value to the controller 300. The second water level sensing part 230 operates electronically or in a manner of using buoyancy, and is installed in the upper side of the first base 130.

The tank cover 240 is rotatably installed on the water supply tank 120, and opens or closes the water supply inlet 126 provided in the water supply tank 120. The tank cover 240 according to an embodiment of the present invention has a plate shape rotatably installed on the water supply tank 120, and is provided with a hole for supplying water to the drain tank 140.

The drain tank 140 is located below the tank cover 240, and the water recovered from the storage chamber 10 falls through the tank cover 240 into the drain tank 140, so that the drain tank 140 is supplied with water.

The drain connector 250 protruding upward from the tank cover 240 is connected with the drain pipe.

The controller 300 receives the measured values of the first water level sensing part 200 and the second water level sensing part 230, respectively, and based on them, can control the operations of a notification part 310, the drain pump 52, and the transfer pump 34.

The notification part 310 informs the user of the state of the tank part 100 through an image, sound, or the like.

Hereinafter, with reference to the accompanying drawings, the operation state of the clothing treatment device 1 according to an embodiment of the present invention will be described in detail.

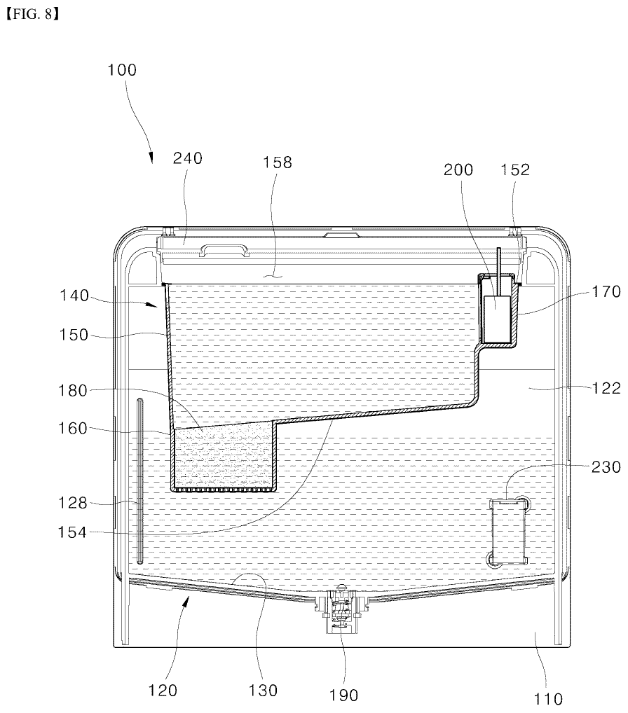

FIG. 8 is a diagram showing a state in which water is stored in the water supply tank 120 according to an embodiment of the present invention.

As shown in FIG. 8, water supplied through the drain connector 250 is stored in the drain tank 140. And in the water supply tank 120 as well, water is stored either to a depth where a portion of the filter part 180 is submerged, or to a depth where the filter part 180 is not submerged.

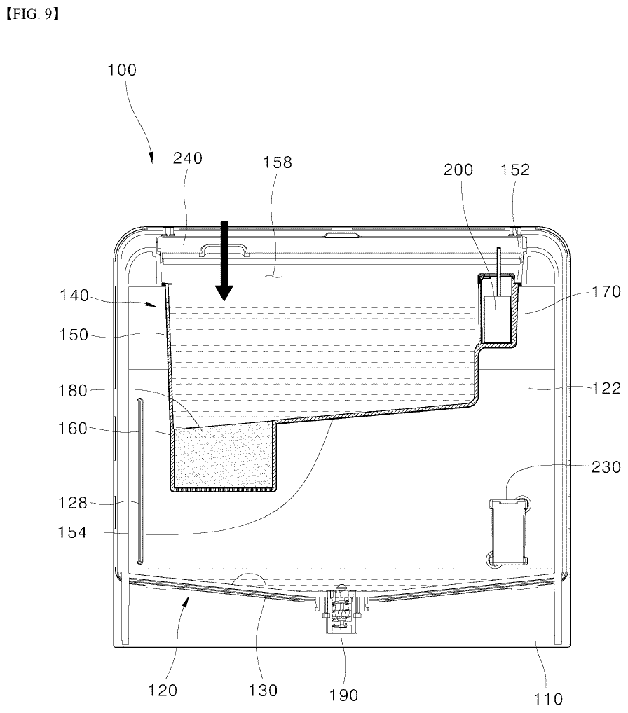

FIG. 9 is a diagram showing a state in which water has entered the drain tank 140 according to an embodiment of the present invention.

As shown in FIG. 9, when an amount of water greater than the amount falling downward through the filter part 180 moves to the steam unit 30 through the drain valve 190, the water level of the water supply tank 120 becomes a low level.

When the second water level sensing part 230 senses the low water level of the water supply tank 120 and sends the measured value to the controller 300, the controller 300 controls the operation of the transfer pump 34 to prevent the outflow of the water stored in the water supply tank 120.

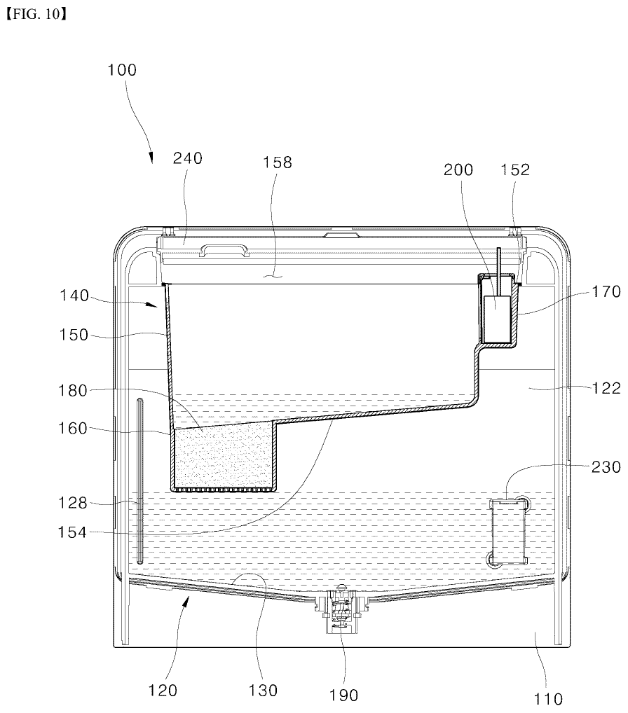

FIG. 10 is a diagram showing a state in which the water stored in the drain tank 140 has moved to the water supply tank 120 through the filter part 180, according to an embodiment of the present invention.

As shown in FIG. 3 and FIG. 10, when the water level in the water supply tank 120 rises due to water that has fallen downward from the drain tank 140 through the filter part 180, the second water level sensing part 230 senses the water level in the water supply tank 120 and sends the measured value to the controller 300. The controller 300 operates the transfer pump 34 to transfer the water stored in the water supply tank 120 to the steam unit 30.

The water sent to the steam unit 30 is heated and converted into steam, then supplied to the clothing placed in the storage chamber 10, and the water containing foreign substances, which has moved to the lower side of the storage chamber 10, is stored in the water collecting tank 50.

The water stored in the water collecting tank 50 moves to the inner side of the drain tank 140 after being moved along the drain pipe by the operation of the drain pump 52.

The water collected in the drain tank 140 is again supplied to the water supply tank 120 through the filter part 180, and after being collected therein, the process of being supplied to the steam unit 30 is repeated.

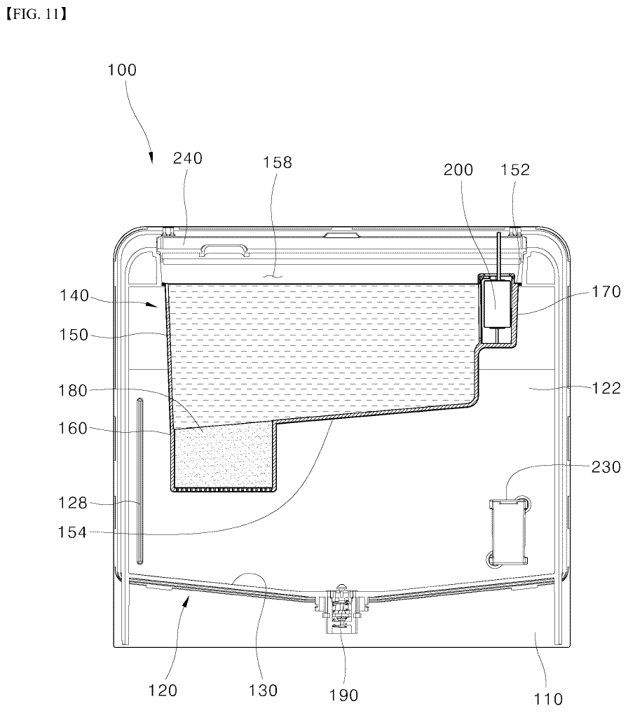

FIG. 11 is a diagram showing a state in which the drain tank 140 is filled with water because the filter part 180 is clogged, according to an embodiment of the present invention.

As shown in FIG. 11, in the case where the filter part 180 is clogged, the water level in the drain tank 140 rises up to or above the set water level. This water-level rise in the drain tank 140 is measured by the first water level sensing part 200, and the measured value is sent to the controller 300.

After stopping the operation of the drain pump 52 for supplying water to the drain tank 140, the controller 300 informs the user of the clog of the filter part 180 through the notification part 310.

By the operation of the controller 300, the additional supply of water to the drain tank 140 is prevented, and a notification recommending replacement or cleaning of the filter part 180 is sent to the user.

Meanwhile, in the case where the low water level in the water supply tank 120 continues, or in the case where the full water level in the water supply tank 120 continues, the controller 300 may also send a notification to the user through the notification part 310, and including this, various modifications are possible.

Although the present invention has been described with reference to the illustrative drawings as the above, the present invention is not limited to the embodiments and drawings disclosed in this specification, and it is obvious that various modifications can be made by those skilled in the art without departing from the scope of the technical concept of the present invention. Additionally, even if the effects related to the configuration of the present invention were not explicitly described while explaining the embodiments of the present invention, it is obvious that the effects predictable from the configuration should also be acknowledged.

1. A clothing treatment device comprising:
a storage chamber in which clothing is stored;
an electrical component chamber located in a lower side of the storage chamber;
a steam unit installed in an inside of the electrical component chamber, and supplying steam to an inside of the storage chamber; and
a tank part installed in the electrical component chamber, filtering water supplied from the storage chamber, and then supplying water to the steam unit.

2. The clothing treatment device of claim 1, wherein the tank part includes:
a water supply tank storing water to be supplied to the steam unit; and
a drain tank detachably installed in an inside of the water supply tank, receiving and filtering water drained from the storage chamber, and then supplying the filtered water to the water supply tank.

3. The clothing treatment device of claim 2, wherein the water supply tank includes:
a tank body installed in a shape surrounding an outer side of the drain tank; and
a water supply inlet forming a passage by opening an upper side of the tank body, through which the drain tank is moved in a vertical direction.

4. The clothing treatment device of claim 2, wherein the drain tank includes:
a storage part having an open upper side to form a drain inlet, engaged in an inside of the water supply tank, and storing therein water that has fallen through the drain inlet; and
a filter mounting part connected to a second base which is a bottom of the storage part, and protruding downward from the storage part to form a space in which a filter part is installed.

5. The clothing treatment device of claim 4, wherein the second base is installed to be inclined downward toward the filter mounting part.

6. The clothing treatment device of claim 4, wherein the filter mounting part, which protrudes downward from the storage part, and in which the filter part is mounted, has an upper side connected with a lower portion of the storage part, and a lower side connected with an inside of the water supply tank.

7. The clothing treatment device of claim 4, wherein a distance between the second base and a first base forming a bottom of the water supply tank is formed to be greater than a distance between the first base and a lower end of the filter mounting part.

8. The clothing treatment device of claim 2, wherein the tank part further includes a front cover coupled to a front surface of the water supply tank, and including a concave groove-shaped handle part to be gripped by a user's hand.

9. The clothing treatment device of claim 2, the tank part further includes a tank cover rotatably installed on the water supply tank to open or close a water supply inlet provided in the water supply tank.

10. The clothing treatment device of claim 9, wherein the drain tank is located below the tank cover, and water recovered from the storage chamber falls into the drain tank through the tank cover.

11. A clothing treatment device comprising:
a storage chamber in which clothing is stored;
an electrical component chamber located in a lower side of the storage chamber;
a steam unit installed in an inside of the electrical component chamber, and supplying steam to an inside of the storage chamber;
a water supply tank storing water to be supplied to the steam unit;
a drain tank detachably installed in an inside of the water supply tank, receiving and filtering water drained from the storage chamber, and then supplying the filtered water to the water supply tank; and
a filter part installed in the drain tank, and purifying water that moves from the drain tank to the water supply tank.

12. The clothing treatment device of claim 11, further comprising:
a tank cover rotatably installed on the water supply tank to open or close a water supply inlet provided in the water supply tank.

13. The clothing treatment device of claim 11, further comprising:
a front cover coupled to a front surface of the water supply tank, and including a concave groove-shaped handle part to be gripped by a user's hand.

14. The clothing treatment device of claim 11, the water supply tank includes:
a tank body installed in a shape surrounding an outer side of the drain tank, and provided with a space therein for storing water falling from the drain tank through the filter part; and
a water supply inlet forming a passage by opening an upper side of the tank body, through which the drain tank is moved in a vertical direction.

15. The clothing treatment device of claim 14, wherein the water supply tank further includes an inner water level window extending in a vertical direction along a surface of the tank body and made of a transparent material to observe a height of water contained in the tank body.

16. The clothing treatment device of claim 11, further comprising:
a drain valve connected to a lower portion of the water supply tank and discharging water when the water supply tank is coupled to the electrical component chamber,
wherein a first base forming a bottom of the water supply tank is installed to be inclined downward toward the drain valve.

17. The clothing treatment device of claim 11, wherein the drain tank includes:
a storage part having an open upper side to form a drain inlet, engaged in an inside of the water supply tank, and storing water therein supplied into an inside of the water supply tank; and
a filter mounting part connected to a second base which is a bottom of the storage part, and protruding downward from the storage part to form a space in which a filter part is installed.

18. The clothing treatment device of claim 17, wherein the filter mounting part, which protrudes downward from the storage part, and in which the filter part is mounted, has an upper side connected with a lower portion of the storage part, and a lower side connected with an inside of the water supply tank.

19. The clothing treatment device of claim 11, further comprising:
a first water level sensing part installed in an inside of the drain tank and measuring a height of water stored in the drain tank.

20. The clothing treatment device of claim 19, further comprising:
a controller receiving a measured value of the first water level sensing part; and
a drain pump operated by a control signal of the controller, and supplying water to the drain tank when a water level in the drain tank is equal to below a set level.
